(19) United States
(12) Patent Application Publication
(10) Pub. No.: US 2026/0295998 A1
(43) Pub. Date: Oct. 1, 2026

(54) INKJET RECORDING APPARATUS, AND CONTROL METHOD FOR CONTROLLING THE INKJET RECORDING APPARATUS

(71) Applicant: CANON KABUSHIKI KAISHA, Tokyo (JP)

(72) Inventors: TAKATSUGU MORIYA, Tokyo (JP); KOICHI ISHIDA, Tokyo (JP)

(21) Appl. No.: 19/568,462

(22) Filed: Mar. 16, 2026

(30) Foreign Application Priority Data
Mar. 28, 2025 (JP) 2025-055316

(51) Int. Cl. B41J 2/045; B41J 2/21; B41J 25/316

(52) U.S. Cl. CPC B41J 2/04556; B41J 2/04586; B41J 2/2103; B41J 25/316

(57) ABSTRACT

An apparatus that performs recording while a discharge head having discharge ports and a recording medium move relative to each other, the apparatus includes the discharge head including a first discharge port line of which the discharge ports are at a first distance as a distance from the recording medium, and a second discharge port line of which the discharge ports are at a second distance as a distance from the recording medium, the second distance being larger than the first distance, wherein, in a case where recording is performed with the first discharge port line positioned ahead of the second discharge port line in a direction of the relative movement, a momentum of droplets discharged from the first discharge port line is lower than a momentum of droplets discharged from the second discharge port line.

### BACKGROUND

### Field of the Technology

The aspect of the embodiments relates to an inkjet recording apparatus using liquid, such as ink, to record on a recording medium, and a control method for the inkjet recording apparatus.

### Description of the Related Art

There has been a growing demand for higher speed and higher image quality in recording of inkjet recording apparatuses. As methods for increasing the recording speed, the number of head scans (the number of passes) is reduced, the head scanning speed is increased, and other types of methods are implemented.

However, these methods involve increase in the discharge frequency of a liquid discharge head, resulting in a remarkably increased air current in a region between the liquid discharge head and the recording medium. The air current between the liquid discharge head and the recording medium generated by the ink discharge interferes with air current generated by a relative movement between the liquid discharge head and the recording medium, forming cylindrical vortexes. Such vortexes may affect the landing positions of discharged ink droplets. If the landing positions of ink droplets are affected, streak-like density unevenness (hereinafter, also referred to as wind ripples) may occur in a recorded image.

To address such density unevenness, for example, Japanese Patent Laid-Open No. 2005-280273 describes a technique of avoiding simultaneous ink discharge from adjacent nozzle lines so that discharged ink droplets are less susceptible to air current generated by the discharged ink, reducing the likelihood of occurrence of the density unevenness. Further, Japanese Patent Laid-Open No. 2016-172357 describes a technique of reducing the amount of ink and the number of ink droplets discharged from the preceding discharge port line so that the following discharge port line is less susceptible to air current generated by the ink discharged from the preceding discharge port line.

As described above, the density unevenness occurs due to interference between the air current generated by the ink discharge between a liquid discharge head and a recording medium and the air current generated by a relative movement between the liquid discharge head and the recording medium. Thus, a relative positional relationship between the liquid discharge head and the recording medium is important.

If a liquid discharge head and a liquid discharge substrate including discharge ports are arranged in a tilted manner, differences occur in the distance between the surface of the liquid discharge head in which the discharge ports are disposed and the recording medium (hereinafter, referred to as the distance between the head and the recording medium). This difference causes difference in inflow air current depending on the scanning direction, making the density unevenness more noticeable. The techniques described in Japanese Patent Laid-Open No. 2005-280273 and Japanese Patent Laid-Open No. 2016-172357 involve control to reduce the number of discharged ink droplets and the amount of ink, which may decrease the print density or the printing speed to reach a desired print density.

### SUMMARY

According to an aspect of the embodiments, an apparatus that performs recording while a discharge head having discharge ports and a recording medium move relative to each other, the apparatus includes the discharge head including a first discharge port line of which the discharge ports are at a first distance as a distance from the recording medium, and a second discharge port line of which the discharge ports are at a second distance as a distance from the recording medium, the second distance being larger than the first distance, wherein, in a case where recording is performed with the first discharge port line positioned ahead of the second discharge port line in a direction of the relative movement, a momentum of droplets discharged from the first discharge port line is lower than a momentum of droplets discharged from the second discharge port line.

Features of the disclosure will become apparent from the following description of embodiments with reference to the attached drawings. The following description of embodiments is described by way of example.

### BRIEF DESCRIPTION OF THE DRAWINGS

FIGS. 1A to 1D are schematic configuration diagrams each illustrating an inkjet recording apparatus and a liquid discharge head in the disclosure.

FIGS. 2A to 2D are diagrams each illustrating an occurrence of vortexes as an issue described in the disclosure.

FIGS. 3A to 3D are diagrams for describing an overview of control processing according to a first embodiment.

FIGS. 4A and 4B are diagrams for describing an overview of control processing according to a second embodiment.

FIGS. 5A to 5D are diagrams for describing an overview of control processing according to a third embodiment.

### DESCRIPTION OF THE EMBODIMENTS

Embodiments of the disclosure will now be described with reference to the attached drawings. In the following description, a recording apparatus using an inkjet recording method will be described as an example. The recording apparatus may be, for example, a single function printer having only a recording function or a multifunction printer having a plurality of functions including a recording function, a facsimile (FAX) function, and a scanner function. The recording apparatus may be a manufacturing device for manufacturing a color filter, an electronic device, an optical device, a microstructure, or the like by using a predetermined recording method.

In the following description, “recording” refers not only to formation of meaningful information, such as characters and figures, but also to formation of information irrespective of whether the information is meaningful. Further, “recording” also broadly refers to forming images, designs, patterns, structures, and the like on recording media regardless of whether such information is manifested in a manner perceptible to human visual perception, or processing media.

A “recording medium” refers to not only paper used in general recording devices, but also cloth, plastic films, metal plates, glass, ceramics, resin, wood, leather, and the like, which are capable of accepting ink.

Further, “ink” should be broadly interpreted in the same manner as the definition of “recording” described above. Thus, “ink” refers to liquid that can be used for formation of images, designs, patterns, and the like, processing a recording medium, and ink processing (for example, the solidification or insolubilization of colorants in the ink applied to a recording medium).

Further, “a recording element” (sometimes also referred to as “a nozzle”) collectively refers to an ink discharge port, a fluid path communicating with the ink discharge port, and an element for generating energy used to discharge the ink.

A recording element substrate for a recording head described below does not refer merely to a base element composed of a silicon semiconductor, but refers to a configuration in which elements, wiring, and the like, are provided.

### Descriptions of Inkjet Recording Apparatus

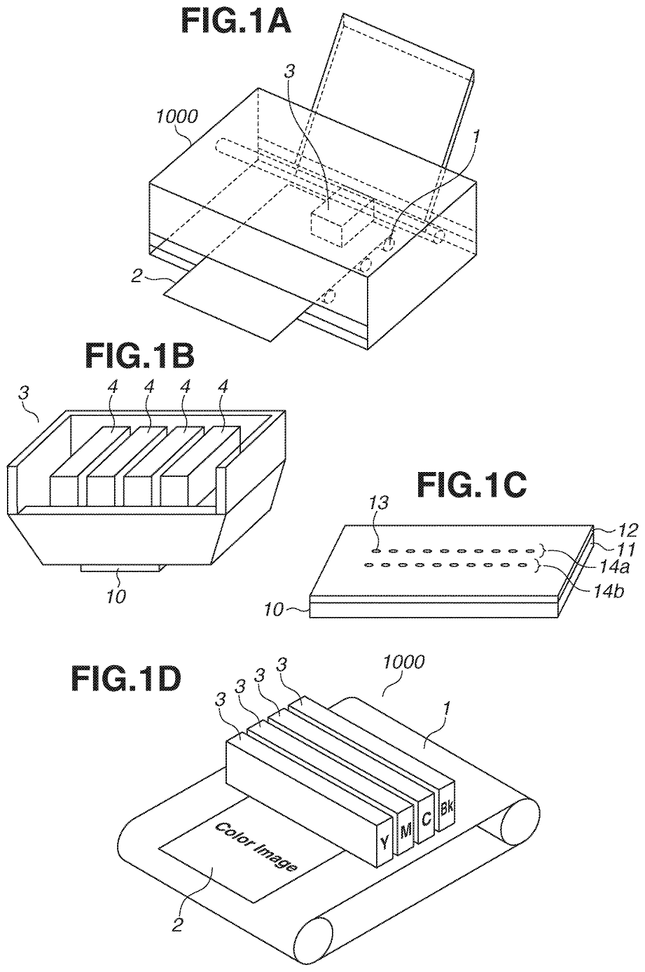

FIG. 1A illustrates a general configuration of an inkjet recording apparatus 1000 according to a first embodiment. The recording apparatus 1000 includes a conveyance unit 1 for conveying a recording medium 2, and a liquid discharge head 3 that scans in a direction substantially perpendicular to the conveyance direction of the recording medium 2. The recording apparatus 1000 repeats an operation of moving the liquid discharge head 3 and conveying the recording medium 2 to perform recording while the liquid discharge head 3 and the recording medium 2 move relative to each other. The recording medium 2 is not limited to cut paper, but may be continuous roll paper.

FIG. 1B is a schematic view illustrating the liquid discharge head 3 according to the embodiment. The liquid discharge head 3 includes a recording element substrate 10 for enabling full-color printing using cyan, magenta, yellow, and black (CMYK) inks. The inks supplied from ink tanks 4 mounted on the liquid discharge head 3 pass through ink supply paths in the liquid discharge head 3 and ink supply paths in the recording element substrate 10, and then are supplied to nozzles in the recording element substrate 10. A pressure generating element is driven in response to a discharge signal from the inkjet recording apparatus 1000, generating pressure in the nozzle. The inks supplied to the nozzles are discharged from discharge ports 13 by the pressure. The discharged ink droplets fly and then land on the recording medium 2 to produce a printed product.

While FIG. 1B illustrates the ink tanks 4 mounted on the liquid discharge head 3, the ink tanks 4 may not be mounted on the liquid discharge head 3. For example, the ink tanks 4 may be disposed in the inkjet recording apparatus 1000, and the inks are supplied from the ink tanks 4 to the liquid discharge head 3 through tubes and the like.

FIG. 1C is an enlarged view illustrating the recording element substrate 10 mounted on the liquid discharge head 3. The recording element substrate 10 is formed by stacking a discharge port forming member 12 on a substrate 11. The substrate 11 is provided with supply ports for supplying ink to the nozzles and pressure generating elements for discharging the ink. The discharge port forming member 12 is provided with a plurality of discharge ports 13 for discharging the ink, and discharge port lines are formed of the plurality of discharge ports 13. In the description of the embodiment, the discharge port lines are distinguished by being referred to as a first discharge port line 14a and a second discharge port line 14b.

The inkjet recording apparatus 1000 according to the embodiment may be a so-called line-head type inkjet recording apparatus as illustrated in FIG. 1D, in which the liquid discharge head 3 does not move and only the recording medium 2 moves. There are two different configurations in the line head type. In one configuration, the inks of the four CMYK colors are supplied to one liquid discharge head 3. In the other configuration, a plurality of liquid discharge heads 3 each of which is used for a single different color is arranged. Either configuration may be employed in the embodiment.

An example of the inkjet recording apparatus 1000 has been described in the embodiment. The inkjet recording apparatus 1000 described above may be implemented as any of the first to third embodiments.

### First Embodiment

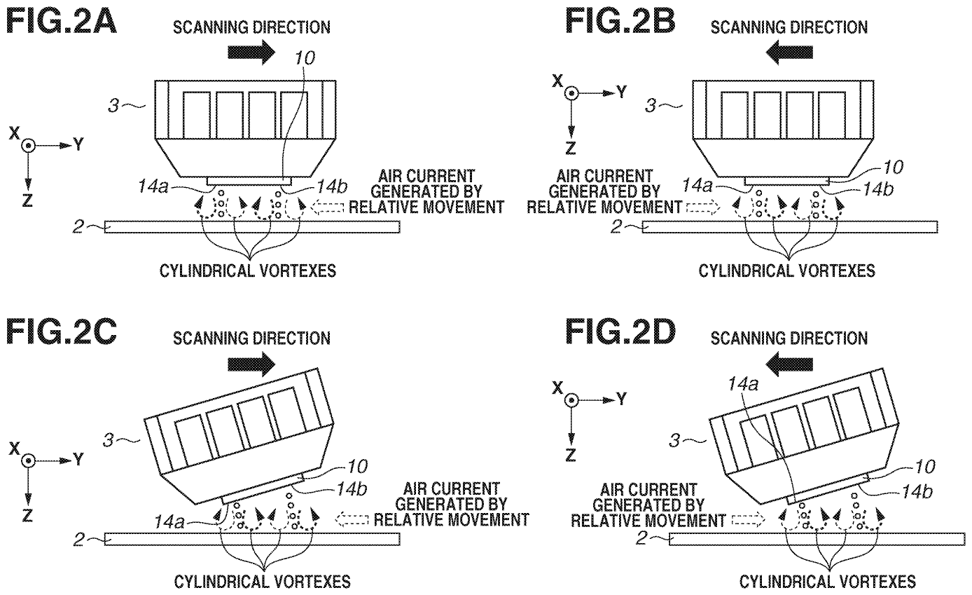

Firstly, the issue addressed by the disclosure will now be described. In the inkjet recording apparatus 1000, air current between the liquid discharge head 3 and the recording medium 2 generated by ink discharge interferes with air current generated by relative movement between the liquid discharge head 3 and the recording medium 2, resulting in an occurrence of cylindrical vortexes. FIGS. 2A and 2B are diagrams for describing occurrences of cylindrical vortexes.

In a case where the conveyance direction of the recording medium 2 is defined as an X direction, the scanning direction of the liquid discharge head 3 is defined as a Y direction, and the direction of the ink discharge from the liquid discharge head 3 is defined as a Z direction, FIG. 2A illustrates an occurrence of cylindrical vortexes when the scanning is performed in the +Y direction. In this case, the air current generated by the relative movement between the liquid discharge head 3 and the recording medium 2 occurs in the-Y direction. The air current interferes with the air current generated by the ink discharge from the discharge port line 14b disposed at the front in the scanning direction (the discharge ports in the +Y direction), resulting in cylindrical vortexes. The cylindrical vortexes then affect the ink discharge from the discharge port line 14a at the rear in the scanning direction (the discharge ports in the-Y direction), resulting in a deviation of an ink landing position on the recording medium 2 from the ideal position.

FIG. 2B illustrates an occurrence of cylindrical vortexes when the scanning direction is the-Y direction opposite to that in FIG. 2A. As a result, the cylindrical vortexes affect the ink discharge from the discharge port line 14b at the rear in the scanning direction (the discharge ports in the +Y direction), resulting in a deviation of an ink landing position on the recording medium 2 from the ideal position.

Density unevenness referred to as wind ripples thus occurs, and the wind ripples may increase when the liquid discharge head 3 or the recording element substrate 10 is tilted. The recording element substrate 10 may be mounted in a tilted state during manufacture of the liquid discharge head 3, or may become tilted when the liquid discharge head 3 is installed into the inkjet recording apparatus 1000. The tilt causes the distance between the liquid discharge head 3 and the recording medium 2 to vary depending on the position of the discharge port line, changing the air current generated by the relative movement between the liquid discharge head 3 and the recording medium 2. As the air current changes, the wind ripples may change and increase.

FIGS. 2C and 2D each illustrate an occurrence of cylindrical vortexes when the liquid discharge head 3 and the recording element substrate 10 are tilted in the Z direction with respect to the recording medium 2. FIG. 2C illustrates an example in which the scanning direction is the +Y direction, and the liquid discharge head 3 is tilted so that the distance between the liquid discharge head 3 and the recording medium 2 decreases in the −Y direction and increases in the +Y direction.

A plurality of discharge ports is arranged in the first discharge port line 14a disposed on one end in a relative movement direction, and a plurality of discharge ports is also arranged in the second discharge port line 14b disposed on the other end in the relative movement direction. In each discharge port line, the distance between the liquid discharge head 3 and the recording medium 2 can be represented by an average value of the distances from the plurality of discharge ports to the recording medium 2.

According to the embodiment, a first distance refers to the average of the distances from the plurality of discharge ports arranged in the first discharge port line 14a to the recording medium 2, and a second distance refers to the average of the distances from the plurality of discharge ports arranged in the second discharge port line 14b to the recording medium 2. The liquid discharge head 3 is tilted in the Z direction with respect to the recording medium 2 so that the first distance is smaller than the second distance.

In the situation illustrated in FIG. 2C, the cylindrical vortexes are weaker on the side where the space is larger and is less susceptible to the impact of wall surfaces (a surface of the liquid discharge head 3 and a surface of the recording medium 2), i.e., on the side with a larger distance between the liquid discharge head 3 and the recording medium 2. Specifically, the cylindrical vortexes become weaker in the +Y direction as the front in the scanning direction and become strong in the-Y direction. Thus, in the situation illustrated in FIG. 2C, the first discharge port line 14a after the preceding second discharge port line 14b is less susceptible to the cylindrical vortexes, resulting in reduced wind ripples.

On the other hand, when the scanning direction is the-Y direction opposite to that in FIG. 2C as illustrated in FIG. 2D, the cylindrical vortexes in the +Y direction at the rear in the scanning direction become strong. Thus, the second discharge port line 14b after the preceding first discharge port line 14a is largely affected by the cylindrical vortexes, which increases wind ripples.

The embodiment provides a solution for the issue of increasing wind ripples depending on the scanning direction when the liquid discharge head 3 and the recording element substrate 10 are tilted in the Z direction with respect to the recording medium 2.

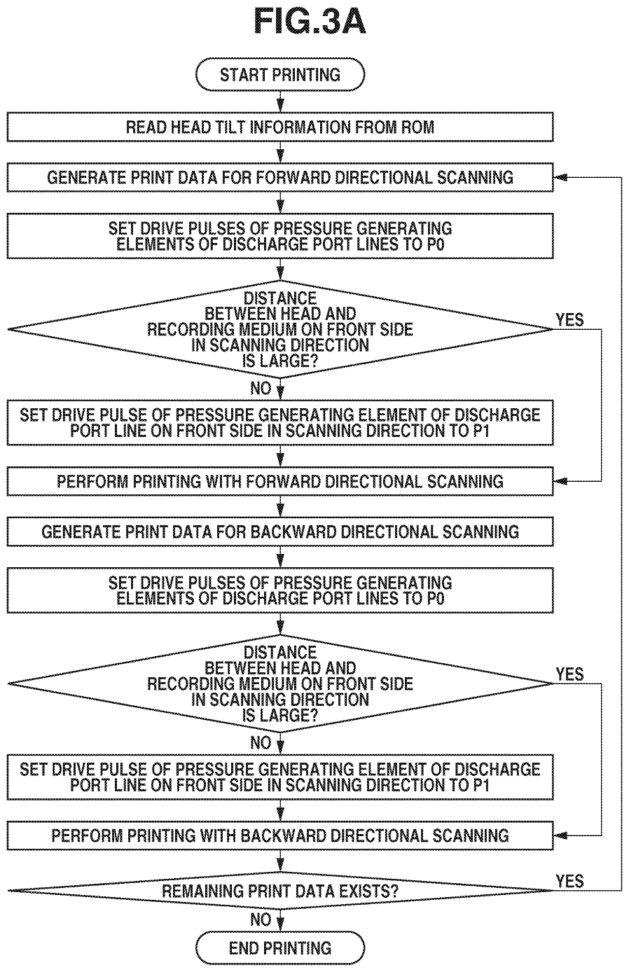

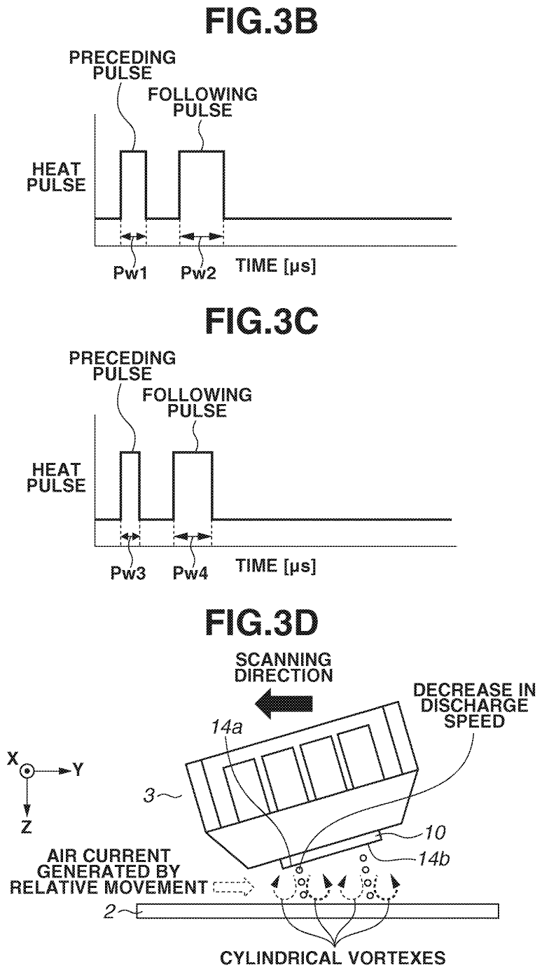

FIG. 3A is a flowchart illustrating control processing executed by a control unit when the embodiment is applied to the above-described issue. In response to the reception of a print instruction, tilt information about the liquid discharge head 3 and the recording element substrate 10 is read from a read only memory (ROM) provided in the liquid discharge head 3 or the inkjet recording apparatus 1000. Examples of the tilt information include values of the distances between the discharge ports 13 and the recording medium 2 at each of the discharge port lines 14a and 14b, and a difference between the distance between the discharge ports 13 and the recording medium 2 at the discharge port line 14a and the distance between the discharge ports 13 and the recording medium 2 at the discharge port line 14b. The distance information may be acquired from the storage device of the inkjet recording apparatus 1000 or from the liquid discharge head 3, or acquired using a detection unit. Further, the distance information may be a rank determined based on a predetermined correspondence table.

Next, the liquid discharge head 3 is moved in the forward direction (e.g., the +Y direction in FIGS. 2A to 2D) to generate print data, and a first input waveform (P0) as a drive pulse used when the liquid discharge head 3 is not tilted with respect to the recording medium 2 is set for the pressure generating elements of the discharge port lines 14a and 14b. Consequently, the tilt information about the liquid discharge head 3 read in advance is referred to, and if the distance between the discharge ports 13 and the recording medium 2 at the front in the scanning direction is larger than at the rear in the scanning direction, the drive pulse is left unchanged. On the other hand, if the distance between the discharge ports 13 and the recording medium 2 at the front in the scanning direction is smaller than at the rear in the scanning direction, the drive pulse of the pressure generating elements in the discharge port line 14a at the front in the scanning direction is changed to a second input waveform (P1).

FIGS. 3B and 3C are diagrams for describing the first input waveform (P0) and the second input waveform (P1) when the drive pulses are used to heat the pressure generating elements as heaters to discharge the ink using bubble pressure. FIG. 3B illustrates the first input waveform (P0) for the non-tilted state. The waveform is a double pulse configured to apply two rectangular pulses, where the pulse width of the preceding pulse is Pw1, and the pulse width of the following pulse is Pw2. FIG. 3C illustrates the second input waveform (P1). The pulse width of the preceding pulse is Pw3, and the pulse width of the following pulse is Pw4. In this case, the relationship is such that Pw1>Pw3 and Pw2>Pw4, and the discharge energy generated by the pressure generating elements with the second input waveform (P1) is smaller than with the first input waveform (P0). As the discharge energy decreases, the discharge speed of droplets decreases to reduce the momentum of the droplets. As a result, this reduces the air current generated by the discharge to decrease the cylindrical vortexes in size, reducing the impact for the discharge port line at the rear in the scanning direction.

The momentum of the droplets discharged from each discharge port line can be represented by an average value of the product of mass and velocity of the droplets discharged from the plurality of discharge ports 13 included in each discharge port line.

According to the embodiment, the average value of the momentum of the plurality of droplets discharged from the plurality of discharge ports arranged in the first discharge port line 14a is smaller than the average value of the momentum of the plurality of the droplets discharged from the plurality of discharge ports arranged in the second discharge port line 14b.

As described above, when the distance between the discharge ports 13 and the recording medium 2 at the front in the scanning direction is smaller than at the rear in the scanning direction, the cylindrical vortexes in the +Y direction as the rear in the scanning direction are strong. Thus, the cylindrical vortexes largely affect the second discharge port line 14b after the preceding first discharge port line 14a, resulting in increased wind ripples. Thus, the momentum of the droplets discharged from the discharge port line at the front in the scanning direction is reduced to weaken the cylindrical vortexes. This makes the droplet landing positions less likely to deviate, resulting in reduced wind ripples.

Also in the backward direction (the-Y direction in FIGS. 2A to 2D as the above-described example), similarly to the manner for the forward direction, the pulse width is changed based on the relationship between the tilt information and the scanning direction of the liquid discharge head 3.

The above-described effect is illustrated in FIG. 3D. FIG. 3D illustrates an example in which the scanning direction is the −Y direction, and the liquid discharge head 3 is tilted so that the distance between the liquid discharge head 3 and the recording medium 2 decreases in the −Y direction (the first distance) and increases in the +Y direction (the second distance). In the example illustrated in FIG. 3D, the cylindrical vortexes generated by the first discharge port line 14a at the front in the scanning direction largely affect the droplets discharged from the second discharge port line 14b at the rear in the scanning direction. To reduce the impact, the drive pulse of the pressure generating elements is changed as illustrated in FIG. 3C to reduce the discharge speed of the droplets from the first discharge port line 14a at the front in the scanning direction. As the discharge speed of the droplets decreases, the impact of the cylindrical vortexes is reduced, allowing the droplets to land at positions closer to the desired positions, resulting in reduced wind ripples.

### Second Embodiment

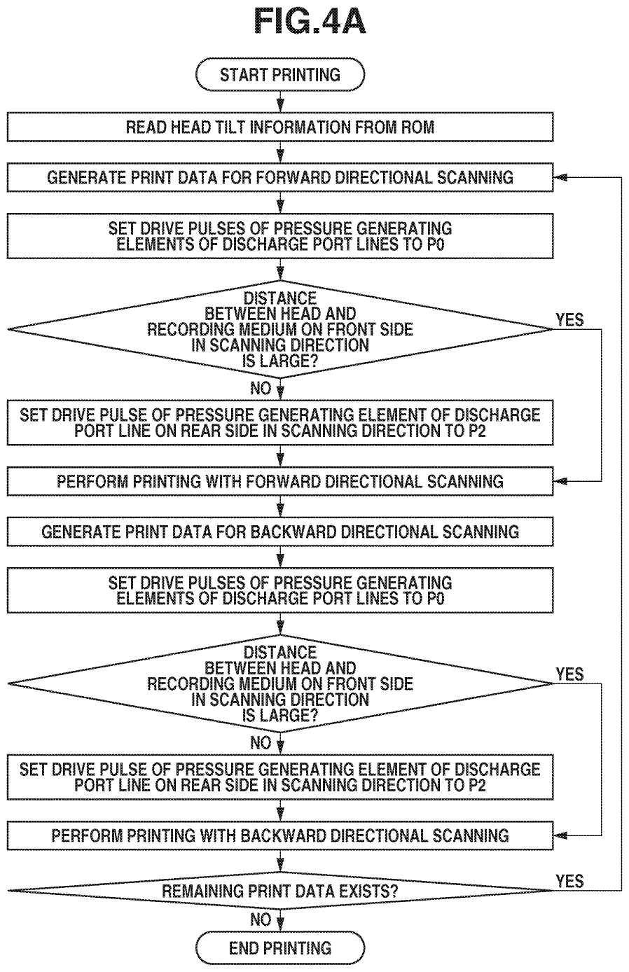

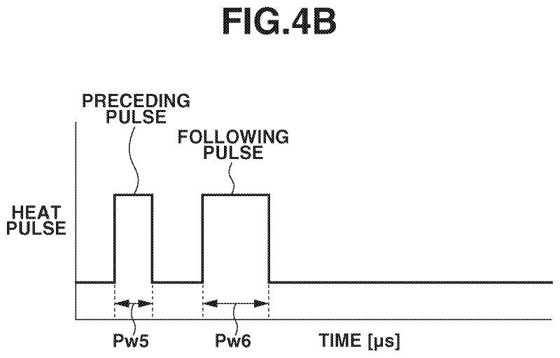

A second embodiment will now be described with reference to FIGS. 4A and 4B. FIG. 4A illustrates an overview of control processing according to the embodiment.

The embodiment differs from the first embodiment in drive pulse used when the distance between the liquid discharge head 3 and the recording medium 2 at the front in the scanning direction is small. In the first embodiment, the drive pulse is changed for the discharge port line at the front in the scanning direction. In the embodiment, the drive pulse is changed for the discharge port line at the rear in the scanning direction.

In the embodiment, tilt information about the liquid discharge head 3 read in advance is referred to, and if the distance between the discharge ports 13 and the recording medium 2 at the front in the scanning direction is larger than at the rear in the scanning direction, the drive pulse is left unchanged. On the other hand, if the distance between the discharge ports 13 and the recording medium 2 at the front in the scanning direction is smaller than at the rear in the scanning direction, the drive pulse of the pressure generating elements in the discharge port line 14a at the rear in the scanning direction is changed to a third input waveform (P2).

FIG. 4B is a diagram for describing the third input waveform (P2), and the first input waveform (P0) according to the embodiment is the same as that in FIG. 3B according to the first embodiment.

In the third input waveform (P2) in FIG. 4B, the pulse width of the preceding pulse is Pw5 and the pulse width of the following pulse is Pw6. In this case, the relationship is such that Pw5>Pw1 and Pw6>Pw2, and the discharge energy generated by the pressure generating elements with the third input waveform (P2) is larger than with the first input waveform (P0). As the discharge energy increases, the discharge speed of droplets increases to increase the momentum of the droplets. As a result, this increases the air current generated by the discharge, and the droplets become less susceptible to the cylindrical vortexes.

If the distance between the discharge ports 13 and the recording medium 2 at the front in the scanning direction is smaller than at the rear in the scanning direction, the cylindrical vortexes in the +Y direction as the rear in the scanning direction become strong. Therefore, the cylindrical vortexes largely affect the second discharge port line 14b after the preceding first discharge port line 14a, resulting in increased wind ripples. Consequently, the momentum of the droplets discharged from the discharge port line at the rear in the scanning direction is increased, and the discharged droplets become less susceptible to the cylindrical vortexes. This makes the droplet landing positions less likely to deviate, resulting in reduced wind ripples.

Also in the backward direction (the −Y direction in FIGS. 2A to 2D as the above-described example), an effect similar to that in the forward direction can be produced by changing the pulse width based on the relationship between the tilt information and the scanning direction of the liquid discharge head 3.

### Third Embodiment

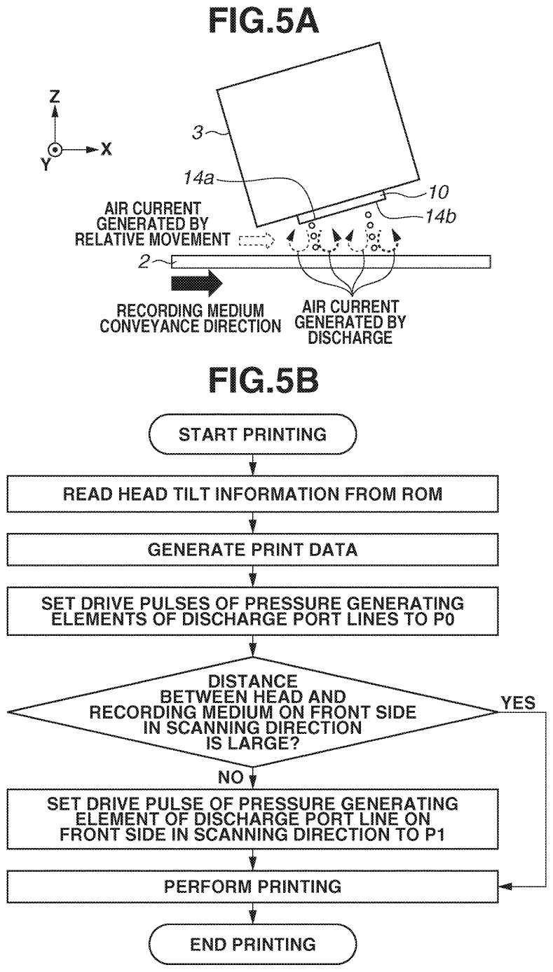

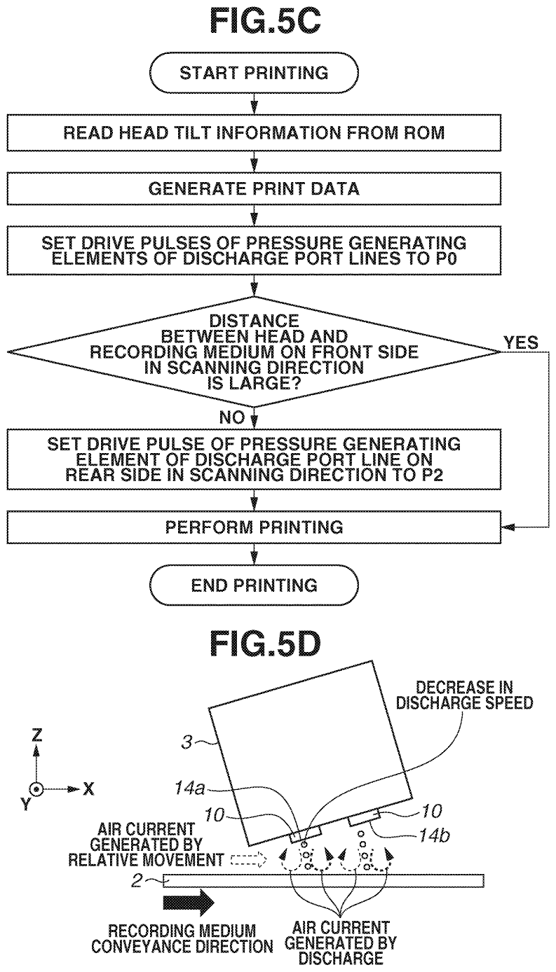

A third embodiment will now be described with reference to FIGS. 5A to 5D. The third embodiment relates to the line head type as illustrated in FIG. 1D. The line head type differs from the above-described type in that the liquid discharge head 3 is fixed, so that the recording medium 2 relatively moves in the conveyance direction.

FIG. 5A illustrates an example in which the recording medium 2 is conveyed in the +X direction, and the liquid discharge head 3 as the line head is tilted so that the distance between the liquid discharge head 3 and the recording medium 2 decreases in the −X direction and increases in the +X direction. In this case, air current generated by the relative movement between the liquid discharge head 3 and the recording medium 2 occurs in the +X direction. Further, the cylindrical vortexes are strong on the side where the space is larger and is less susceptible to the impact of the wall surfaces (the surface of the liquid discharge head 3 and the surface of the recording medium 2), i.e., on the side with a larger distance between the liquid discharge head 3 and the recording medium 2.

Specifically, the cylindrical vortexes become strong in the +X direction as the rear in the conveyance direction and the cylindrical vortexes become weaker in the −X direction.

Thus, in the situation illustrated in FIG. 5A, the cylindrical vortexes largely affect the second discharge port line 14b after the preceding first discharge port line 14a, resulting in increased wind ripples.

In such a situation, wind ripples are reduced by performing control processing as illustrated in FIGS. 5B and 5C. In the control processing illustrated in FIG. 5B, firstly, tilt information about the liquid discharge head 3 and the recording element substrate 10 is read from the ROM provided in the liquid discharge head 3 or the inkjet recording apparatus 1000.

The first input waveform (P0) used when the liquid discharge head 3 is not tilted is set for the pressure generating elements of the discharge port lines 14a and 14b. Consequently, the tilt information about the liquid discharge head 3 read in advance is referred to, and if the distance between the discharge ports 13 and the recording medium 2 at the front in the conveyance direction is larger than at the rear in the conveyance direction, the drive pulse is not changed from P0. On the other hand, if the distance between the discharge ports 13 and the recording medium 2 at the front in the conveyance direction is smaller than at the rear in the conveyance direction, the drive pulse of the pressure generating elements in the discharge port line 14a at the front in the scanning direction is changed to P1.

As described above in the first embodiment, the second input waveform (P1) provides smaller discharge energy generated by the pressure generating elements than the first input waveform (P0) does. As the discharge energy decreases, the discharge speed of droplets decreases to reduce the momentum of the droplets. As a result, this reduces the air current generated by the discharge to decrease the cylindrical vortexes in size, reducing the impact for the discharge port line at the rear in the scanning direction.

With this effect, the droplets discharged from the discharge port line 14b at the rear in the conveyance direction land at positions closer to the desired positions, resulting in reduced wind ripples.

In the control processing in FIG. 5C, the tilt information about the liquid discharge head 3 is referred to, and if the distance between the discharge ports 13 and the recording medium 2 at the front in the conveyance direction is larger than at the rear in the conveyance direction, the drive pulse is not changed from P0. On the other hand, if the distance between the discharge ports 13 and the recording medium 2 at the front in the conveyance direction is smaller than at the rear in the conveyance direction, the drive pulse of the pressure generating elements in the discharge port line 14a at the rear in the scanning direction is changed to P2.

As described above in the second embodiment, the third input waveform (P2) provides larger discharge energy generated by the pressure generating elements than the first input waveform (P0) does. As the discharge energy increases, the discharge speed of droplets increases to increase the momentum of the droplets. As a result, this increases the air current generated by the discharge, and the droplets become less susceptible to the cylindrical vortexes. By increasing the momentum of the droplets discharged from the discharge port line 14b at the rear in the scanning direction to make the discharged droplets less susceptible to the cylindrical vortexes, the droplet landing positions are less likely to deviate, resulting in reduced wind ripples.

As in the line head type according to the embodiment, if the direction of the relative movement between the recording head 3 and the recording medium 2 is constant, it is possible not to use the control unit to control the above-described drive pulse. In other words, this holds true in a case where the liquid discharge head 3 is tilted so that the distance between the liquid discharge head 3 and the recording medium 2 in the-X direction is constantly small and the distance between the liquid discharge head 3 and the recording medium 2 in the +X direction is constantly large as illustrated in FIG. 5A. In this case, the momentum of the droplets to be discharged may be preset based on structural differences between the liquid discharge nozzles of the first discharge port line 14a at the front in the conveyance direction and the second discharge port line 14b at the rear in the conveyance direction. As described above, difference in the momentum due to structural factors independent of the control unit allows the discharged droplets to be less susceptible to cylindrical vortexes generated by the self-induced airflow at the discharge port line at the front in the conveyance direction. This makes the droplet landing positions less likely to deviate, resulting in reduced wind ripples.

The disclosure is also similarly applicable to a configuration even with a plurality of recording element substrates 10 provided.

As illustrated in FIG. 5D, the first discharge port line 14a and the second discharge port line 14b can be disposed in recording element substrates 10 different from each other, respectively. Even in this case, wind ripples can be reduced by performing the control processing illustrated in FIG. 5B based on the tilt of the liquid discharge head 3.

According to the first to the third embodiments, the tilt information about the liquid discharge head 3 may be stored in the ROM provided in the liquid discharge head 3 or the inkjet recording apparatus 1000 at the beginning of the control. The tilt information may be values measured by a distance detection unit in the inkjet recording apparatus 1000.

As the distance detection unit, for example, the user may visually check patterns recorded at the first discharge port line 14a and the second discharge port line 14b which the inkjet recording apparatus 1000 has obtained for deviations from the desired positions. Alternatively, the determination may be made based on patterns read by a scanner. Further, an optical sensor may be provided in the inkjet recording apparatus 1000.

The tilt information can be obtained by directly measuring the positions of the first discharge port line 14a and the second discharge port line 14b in the liquid discharge head 3 using the optical sensor.

Even in a case where the inkjet recording apparatus 1000 can measure the tilt information about the liquid discharge head 3 as described above, in one embodiment, the measurement result is stored in the ROM provided in the liquid discharge head 3 or the inkjet recording apparatus 1000. Storing the measurement result in the ROM enables reducing the time taken to measure the tilt information, which reduces the time taken to complete printing.

According to the configurations of the disclosure, the discharge speed of droplets is changed based on a difference in distance between the recording medium and the discharge ports resulting from a tilt of the liquid discharge head. As a result, an inkjet recording apparatus can be provided, which is capable of reducing density unevenness by reducing the difference in inflow air current due to the difference in distance between the liquid discharge head and the recording medium.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-055316, filed Mar. 28, 2025, which is hereby incorporated by reference herein in its entirety.

What is claimed is:

1. An apparatus that performs recording while a discharge head having discharge ports and a recording medium move relative to each other, the apparatus comprising:
the discharge head including a first discharge port line of which the discharge ports are at a first distance as a distance from the recording medium, and a second discharge port line of which the discharge ports are at a second distance as a distance from the recording medium, the second distance being larger than the first distance,
wherein, in a case where recording is performed with the first discharge port line positioned ahead of the second discharge port line in a direction of the relative movement, a momentum of droplets discharged from the first discharge port line is lower than a momentum of droplets discharged from the second discharge port line.

2. The apparatus according to claim 1, further comprising a control unit configured to control the momentum of the discharged droplets based on information about the distance between the recording medium and the discharge ports.

3. The apparatus according to claim 2, further comprising a storage unit configured to store the information about the distance between the recording medium and the discharge ports.

4. The apparatus according to claim 1, further comprising a detection unit configured to obtain the first distance and the second distance.

5. The apparatus according to claim 4,
wherein the detection unit is a scanner, and
wherein the information about the distance between the recording medium and the discharge ports is obtained by acquiring an image of a predetermined pattern using the scanner.

6. The apparatus according to claim 4, wherein the detection unit is a sensor.

7. The apparatus according to claim 1, wherein the discharge head includes a plurality of substrates provided with the discharge ports.

8. The apparatus according to claim 2, wherein the control unit controls a discharge speed of the droplets discharged from the first discharge port line to be lower than a discharge speed of the droplets discharged from the second discharge port line.

9. The apparatus according to claim 2, wherein the control unit controls a discharge speed of the droplets discharged from the second discharge port line to be higher than a discharge speed of the droplets discharged from the first discharge port line.

10. The apparatus according to claim 1, wherein a plurality of the discharge heads is provided.

11. A method for an apparatus that performs recording while a discharge head having discharge ports and a recording medium move relative to each other, the discharge head including a first discharge port line of which the discharge ports are at a first distance as a distance from the recording medium, and a second discharge port line of which the discharge ports are at a second distance as a distance from the recording medium, the second distance being larger than the first distance, the method comprising controlling, in a case where recording is performed with the first discharge port line positioned ahead of the second discharge port line in a direction of the relative movement, a momentum of droplets discharged from the first discharge port line to be lower than a momentum of droplets discharged from the second discharge port line.

12. The method according to claim 11, further comprising controlling the momentum of the discharged droplets based on information about the distance between the recording medium and the discharge ports.

13. The method according to claim 12, further comprising storing the information about the distance between the recording medium and the discharge ports.

14. The method according to claim 11, further comprising obtaining the first distance and the second distance.

15. The method according to claim 14, wherein the information about the distance between the recording medium and the discharge ports is obtained by acquiring an image of a predetermined pattern using a scanner.

16. The method according to claim 11, wherein the liquid discharge head includes a plurality of recording element substrates provided with the discharge ports.

17. The method according to claim 12, wherein the controlling controls a discharge speed of the droplets discharged from the first discharge port line to be lower than a discharge speed of the droplets discharged from the second discharge port line.

18. The method according to claim 12, wherein the controlling controls a discharge speed of the droplets discharged from the second discharge port line to be higher than a discharge speed of the droplets discharged from the first discharge port line.
